(19) United States
(12) Patent Application Publication
(10) Pub. No.: US 2009/0260318 A1
(43) Pub. Date: Oct. 22, 2009

(54) Safety cap and string snapping apparatus

(76) Inventor: Bob Brooks, Paso Robles, CA (US)

Correspondence Address: LAW OFFICES OF ANDREW SCHROEDER, P.O. Box 6731, Santa Maria, CA, 93454, US

(21) Appl. No.: 11/827,740

(22) Filed: Jul. 14, 2007

(51) Int. Cl. E04F 21/165; B25G 1/10; B25G 1/00

(52) U.S. Cl. 52/749.13; 16/430; 16/110.1

(57) ABSTRACT

A safety cap and string snapping apparatus for a concrete finishing pole includes a resilient member to be affixed to a concrete finishing pole. The resilient member comprises a mating member and a protective end. The mating member is circular.

### FIELD OF THE INVENTION

The present invention relates with the construction industry and more particularly pertains to poles used for concrete placement.

### BACKGROUND OF THE INVENTION

The process of pouring, finishing, and curing concrete is a very labor intensive endeavor. In most jobs there are several people walking about performing various tasks such as constructing the forms, pouring the concrete, leveling and finishing the concrete etc. Many of these workers are solely concentrating on their task, their target on a slab, or their tools. As a consequence they are oftentimes unaware of other workers or dangers around them.

In many concrete pouring and placement operations such as sidewalks, expansion joints must be placed in the concrete. Expansion joints are made first by snapping a line onto the wet concrete. This indicates where the expansion joint is to be cut.

After this line is visible, the person uses a tool which is affixed to one end of a long concrete pole. This deep joint tool is used to cut the expansion joint. Since cutting the expansion joint requires great concentration and accuracy, the person must focus solely upon what is directly in front of him. He is completely oblivious to where the pole is moving behind him. Since these poles can stretch for over 25 feet long oftentimes the ends of these poles inadvertently hits other workers or property such as concrete pumps, cars, etc. In some cases these accidents can lead to injury. And in others it can lead to paint chips and other serious property damage.

Therefore, what is clearly needed in the marketplace is a safety device to be placed on the ends of concrete poles. These safety devices should be soft enough such that when there is impact with a person or property little damage will ensue. Moreover, this device may further incorporate another function for placement of a snapping string for the purpose of indicating where an expansion joint should be placed.

### SUMMARY OF THE INVENTION

It is an object of the present invention to provide a device for the purpose of protecting people, property, and equipment from impact from the end of a concrete pole. This device is soft and resilient enough to cushion the impact upon the person or object it contacts.

It is an object of the present invention to provide an apparatus for the purpose of enabling a person to set out a line in wet concrete for the purpose of delineating a line where an expansion joint must be placed. This should be placed at the end of a long pole.

### BRIEF DESCRIPTION OF THE DRAWING FIGURES

FIG. 1 is a plan view of a preferred embodiment of the present invention.

FIG. 2 is a side view of a preferred embodiment of the present invention.

FIG. 3 is a plan view of a preferred embodiment of the present invention.

FIG. 4 is a perspective view of a preferred embodiment of the present invention.

FIG. 5 is a perspective view of a preferred embodiment of the present invention.

FIG. 6 is a plan view of a preferred embodiment of the present invention.

FIG. 7 is a side view of a preferred embodiment of the present invention.

FIG. 8 is a plan view of a preferred embodiment of the present invention.

FIG. 9 is a perspective view of a preferred embodiment of the present invention.

FIG. 10 is a perspective view of a preferred embodiment of the present invention.

FIG. 11 is a perspective view of a preferred embodiment of the present invention.

FIG. 12 is a perspective view of a preferred embodiment of the present invention.

FIG. 13 is a perspective view of a preferred embodiment of the present invention.

FIG. 14 is a perspective view of a preferred embodiment of the present invention.

FIG. 15 is a perspective view of a preferred embodiment of the present invention.

FIG. 16 is a plan view of a preferred embodiment of the present invention.

FIG. 17a is a side view of a preferred embodiment of the present invention.

FIG. 17b is a plan view of a preferred embodiment of the present invention.

FIG. 17c is a plan view of a preferred embodiment of the present invention.

FIG. 18a is a plan view of a preferred embodiment of the present invention.

FIG. 18b is a side view of a preferred embodiment of the present invention.

FIG. 18c is a plan view of a preferred embodiment of the present invention.

### DESCRIPTION OF PREFERRED EMBODIMENTS

According to a preferred embodiment of the present invention, a safety device is used for the purpose of creating a safe workplace for concrete finishing and placement. The present invention is described in enabling detail below.

For the purposes of the present invention the term “concrete pole” or “concrete finishing pole” shall hereafter refer and describe those poles used in conjunction with bull floats, Fresnos various deep joint tools and other attendant apparatus used for cutting expansion joints, leveling concrete, finishing concrete, and other attendant tasks and activities.

For the purposes of the present invention, the term “resilient” refers to the quality of a material to be soft. This quality or property is similar to that found in sponge and is expedient for the purpose of decreasing the force of impact.

For the purposes of the present invention the term “affix” shall mean attaching something to another object. This means of attachment should not be construed to be permanent. This means of attachment can either be permanent or temporary.

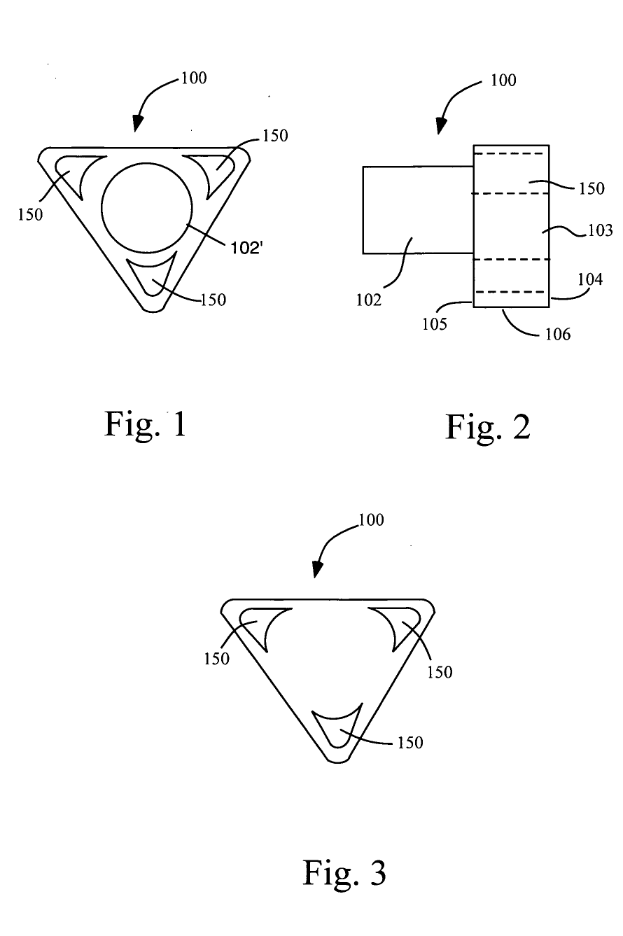

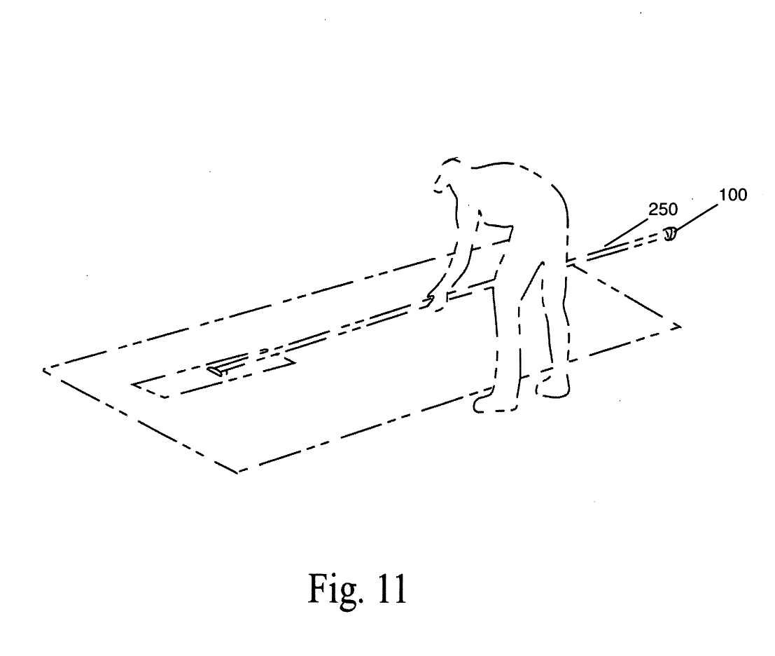

FIG. 1 illustrates a preferred embodiment of the present invention. A safety cap and string snapping apparatus 100 (hereafter Cap 100) for a concrete finishing pole is a resilient member to be affixed to a concrete finishing pole. The resilient member comprises a mating member 102 and a protective end 103. In some preferred embodiments the mating member is circular. FIG. 11 illustrates how the invention is disposed on a pole 250.

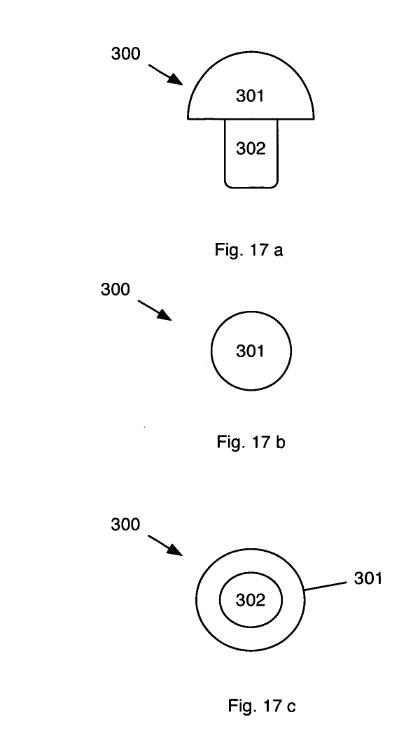

In some preferred embodiments the protective end comprises a first side 104, a second side 105 and at least one lateral surface 106. However, in other preferred embodiments the cap may be mushroomed shaped as illustrated in FIGS. 17a-c. In this alternative embodiment the cap 300 has a mating end 302 and a top end 301.

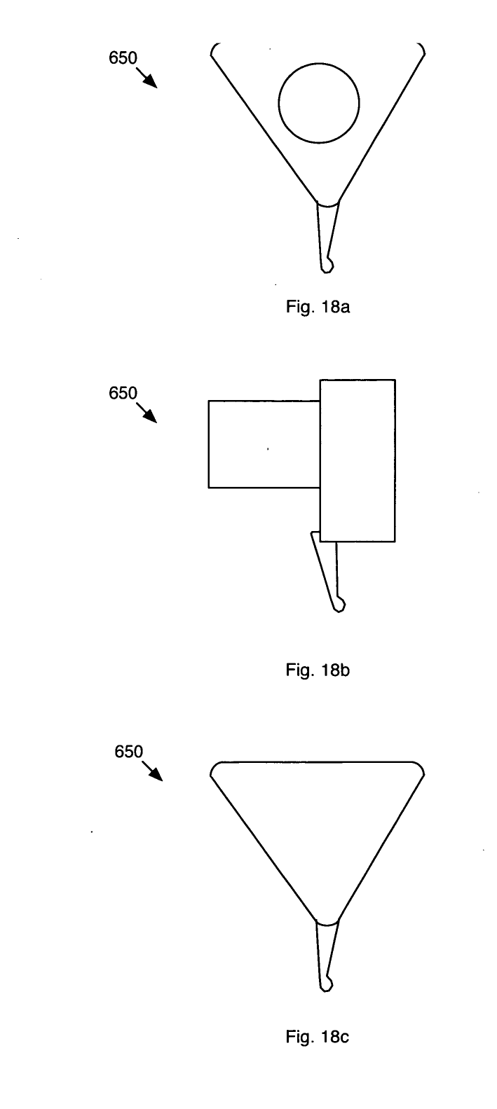

In addition, in some preferred embodiments the cap may further comprise at least one string orifice 150 for the purpose of connecting a string to the cap. However, other preferred embodiments may not have the string orifice such as those preferred embodiments depicted in FIGS. 18a-c wherein the alternative preferred embodiment is denoted as FIG. 650.

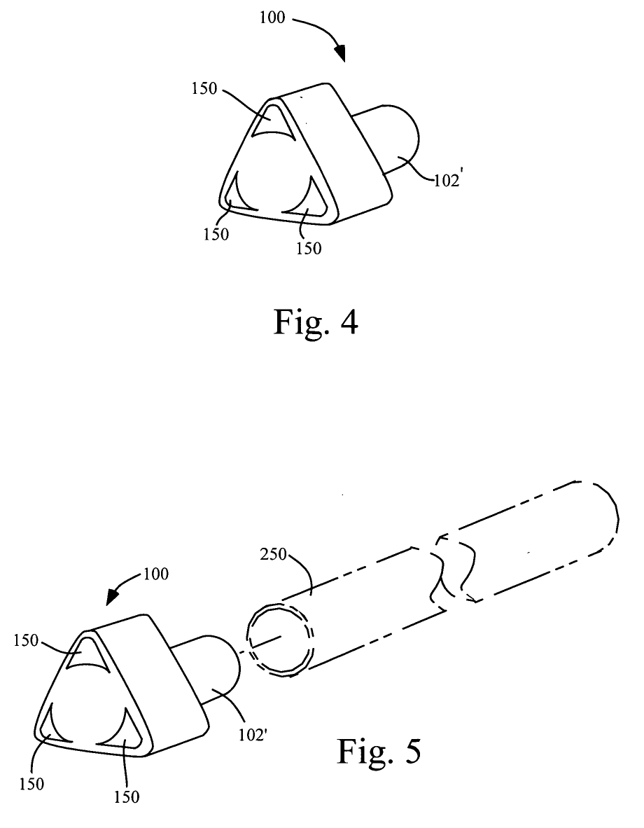

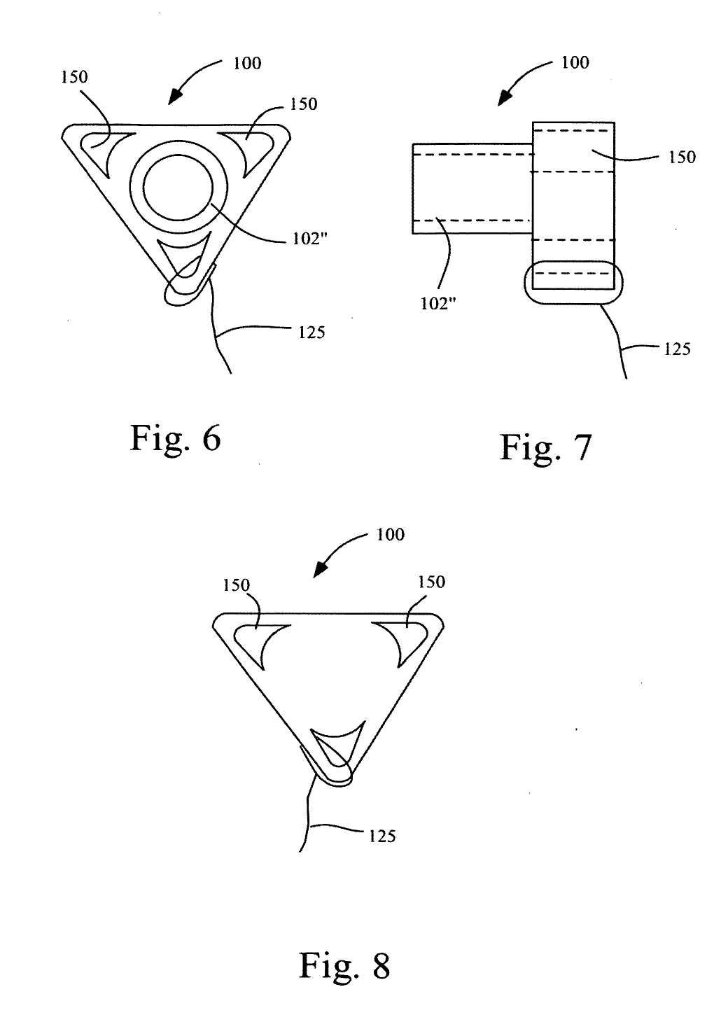

In some preferred embodiments the mating member may either be a male end as illustrated in FIGS. 1-5. The male end is denoted by 102′ and the female end is denoted by 102″. In other preferred embodiments the mating member may be a female end as illustrated in FIGS. 6-10. These ends are sized to create an interference fit with the concrete finishing pole. It should be noted here that the female end version may be alternatively used as a male end with some poles and still be able to affix to other poles as a female end.

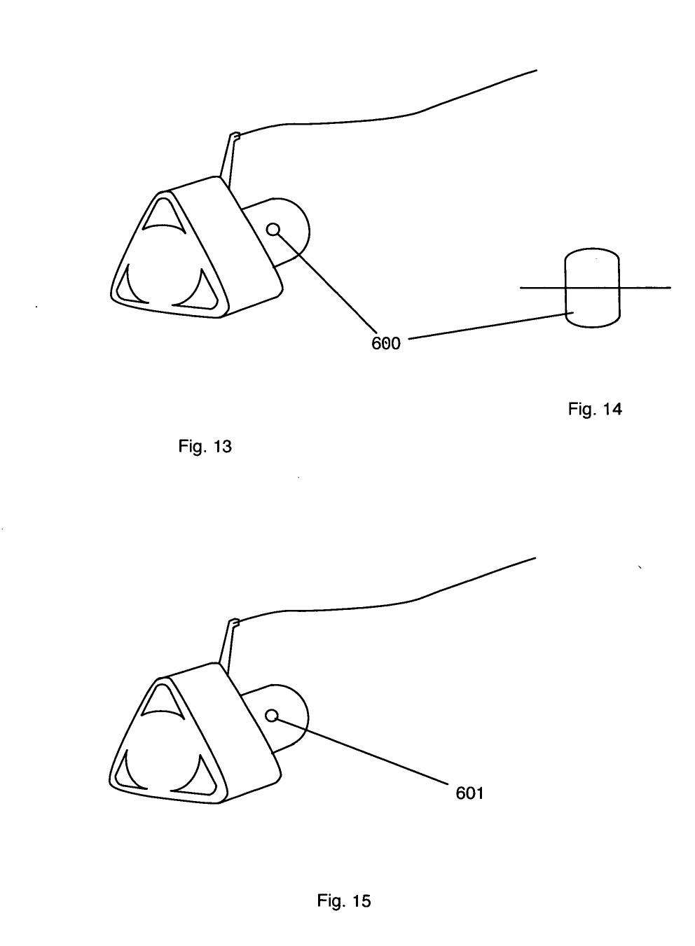

In some preferred embodiments illustrated in FIGS. 13-14 the cap may further include a detent 600 for the purpose of securing the cap to the pole. FIG. 15 illustrates one preferred embodiment where a detent orifice 601 is used for the purpose of receiving a detent which is incorporated into some poles. It should be pointed out here that these embodiments are optional.

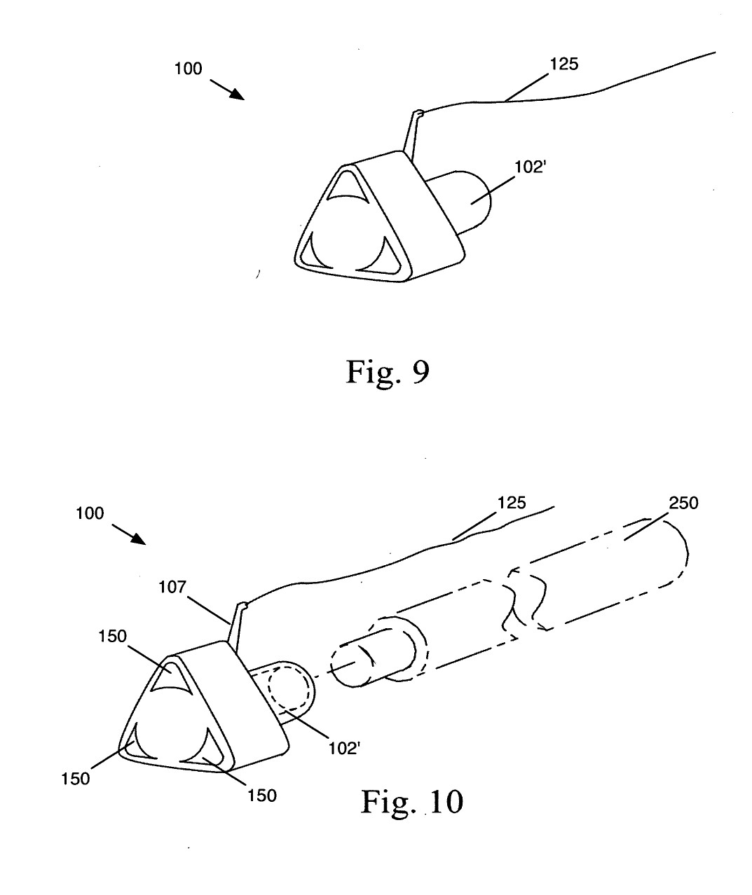

FIG. 9 also illustrates that in some preferred embodiments the device may further include an attachment piece 107 for use in using a snapping string 125. This attachment piece may be affixed to the device in many ways appreciable to one skilled in the art. In many preferred embodiments it may be desirable to have the attachment piece molded into the cap itself. The snapping string 125 is tied onto the attachment piece. The snapping string is used for the purpose of demarking a line in the wet concrete slab where the expansion joint is intended to be placed. It should be noted here that in some preferred embodiments the snapping string is simply affixed with the cap by tying it with the string orifice 150.

In other preferred embodiments the mating member may be capable of both mating as either male or female as illustrated in FIGS. 6, 7, and 10. Whether used in the male or female embodiment the mating piece is sized to create an interference fit with the pole. Moreover, the mating end must be rigid enough to maintain its position on the pole.

FIGS. 1-11 illustrate that in some preferred embodiments the safety cap is shaped into a triangle. However, other preferred embodiments may be shaped in other configurations such as squares, rectangles, circles, spheres, etc. The possibilities are endless.

The safety cap may be comprised of a number of different materials. These materials should be soft and resilient such that any impact with the safety cap will not produce great damage or pain upon impact. Exemplary materials in some preferred embodiments include rubber, sponge, plastic, or Styrofoam® (a Federally registered Trademark for polystyrene thermal insulation). Other materials may also be used so the scope of the present invention should not be limited to these particular materials.

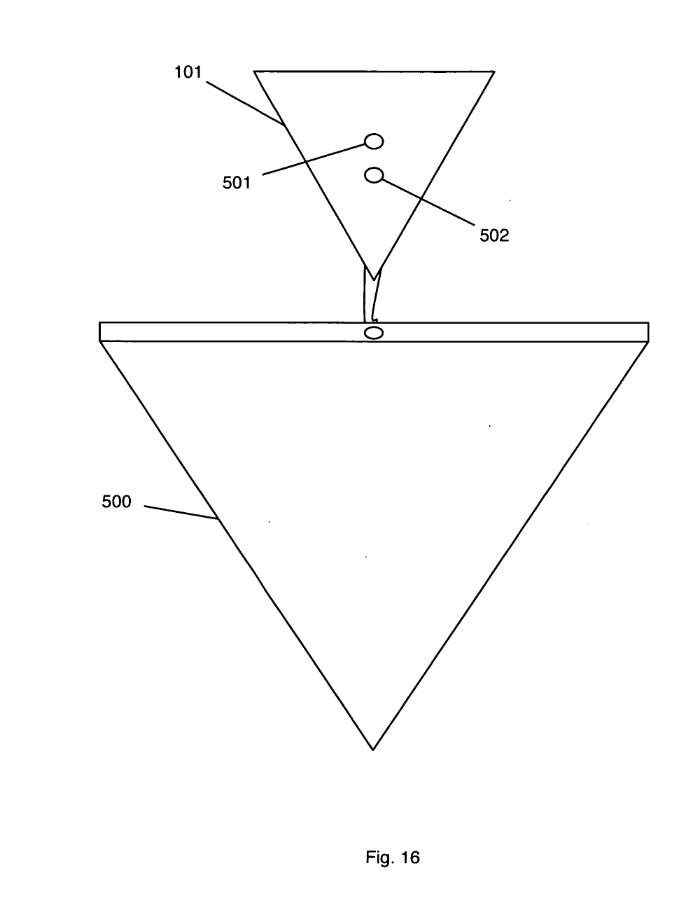

FIG. 16 illustrates that in some preferred embodiments the device may further comprise a flag 500 and/or an LED light 501 to be embedded into the safety cap. The purpose of the flag is to warn others that a danger is present and that they need to walk around the pole from a safe distance. The LED light may be used in those situations during dusk or nighttime hours. In other preferred embodiments a beeper 502 may also be incorporated into the cap in order to warn others of its current use.

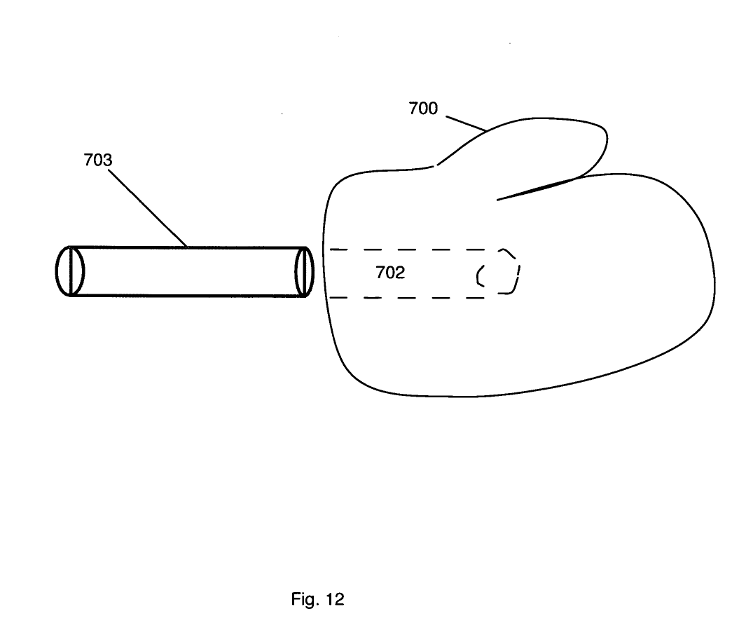

FIG. 12 also illustrates another preferred embodiment wherein the cap is shaped into a boxing glove 700. This preferred embodiment further comprises a receiving orifice 702 for the purpose of receiving a finishing pole 703. Other preferred embodiments of this sort may be shaped into a panoply of other figures or figurines to give a more ornamental and aesthetic look. The possibilities are endless.

Those skilled in the art will appreciate numerous variations in the present system, configuration and operation that are within the scope of the invention. Those skilled in the art will also appreciate how the principles illustrated in these preferred embodiments can be used in other examples of the invention. A particular reference number in one figure refers to the same element in all of the other figures.

Moreover, It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A safety cap and string snapping apparatus for a concrete finishing pole comprising:
a resilient member to be affixed to a concrete finishing pole;
the resilient member comprises a mating member and a protective end;
the mating member affixes to the concrete finishing pole.

2. The safety cap and string snapping apparatus for a concrete finishing pole of claim 1 wherein the mating member is a male end for insertion into the concrete finishing pole.

3. The safety cap and string snapping apparatus for a concrete finishing pole of claim 1 wherein the mating member is a female end for affixation with the concrete finishing pole.

4. The safety cap and string snapping apparatus for a concrete finishing pole of claim 1 wherein the mating member is capable of either male insertion or female insertion; the mating member is sized to create an interference fit with the pole.

5. The safety cap and string snapping apparatus for a concrete finishing pole of claim 1 further comprising an attachment piece for use with a string; the attachment piece is affixed to the resilient member.

6. The safety cap and string snapping apparatus for a concrete finishing pole of claim 5 further comprising a string for use with marking an expansion joint on a concrete slab; the string is affixed to the attachment piece.

7. The safety cap and string snapping apparatus for a concrete finishing pole of claim 6 further comprising a flag.

8. The safety cap and string snapping apparatus for a concrete finishing pole of claim 1 wherein the first side and the second side of the resilient member is triangularly-shaped.

9. The safety cap and string snapping apparatus for a concrete finishing pole of claim 1 wherein the first side of the resilient member further comprises an LED light.

10. The safety cap and string snapping apparatus for a concrete finishing pole of claim 1 wherein the resilient member further comprises a string orifice, the string orifice is used for the purpose of tying a string to the safety cap.

11. The safety cap and string snapping apparatus for a concrete finishing pole of claim 1 further comprising a detent.

12. The safety cap and string snapping apparatus for a concrete finishing pole of claim 1 wherein the resilient member is comprised of sponge.

13. The safety cap and string snapping apparatus for a concrete finishing pole of claim 1 wherein the resilient member is comprised of rubber.

14. The safety cap and string snapping apparatus for a concrete finishing pole of claim 1 wherein the resilient member is comprised of plastic.

15. The safety cap and string snapping apparatus for a concrete finishing pole of claim 1 wherein the resilient member is comprised of polystyrene.

16. The safety cap and string snapping apparatus for a concrete finishing pole of claim 1 further comprising a detent orifice.

17. A safety cap apparatus for a concrete finishing pole comprising: a cap to be disposed on a distal end of a concrete finishing pole; the cap is comprised of a mating orifice and a resilient end.

18. The safety cap of claim 17 wherein the resilient end is triangularly-shaped.

19. The safety cap of claim 18 wherein the resilient end is the shape of a boxing glove.

20. The safety cap of claim 19 further comprising a snapping string for the purpose of marking an expansion joint in wet concrete.
